(19) United States
(12) Patent Application Publication
(10) Pub. No.: US 2018/0030581 A1
(43) Pub. Date: Feb. 1, 2018

(54) METHOD FOR MANUFACTURING ALUMINUM DIE-CASTING ARTICLE FOR PLASTIC WORKING AND FIXATION STRUCTURE USING ALUMINUM DIE-CASTING ARTICLE

(71) Applicant: SUMITOMO RIKO COMPANY LIMITED, Komaki-shi (JP)

(72) Inventors: Wakako MICHIYAMA, Komaki-shi (JP); Motoshige HIBINO, Komaki-shi (JP); Hiroki UNO, Komaki-shi (JP)

(73) Assignee: SUMITOMO RIKO COMPANY LIMITED, Komaki-shi (JP)

(21) Appl. No.: 15/641,888

(22) Filed: Jul. 5, 2017

(30) Foreign Application Priority Data
Jul. 26, 2016 (JP) 2016-146113

(51) Int. Cl. C22F 1/04; B22D 17/00

(52) U.S. Cl. CPC C22F 1/04; B22D 17/00; F16L 55/041

(57) ABSTRACT

A method for manufacturing an aluminum die-casting article for plastic working constituting a fixation structure between a vibration-damping device or a vibration-damping hose component and a vibration transmission member by plastic working, the method including: a die casting step of molding the aluminum die-casting article for plastic working, by normal die casting; and a heat treatment step of performing annealing heat treatment on the molded aluminum die-casting article for plastic working.

### INCORPORATED BY REFERENCE

The disclosure of Japanese Patent Application No. 2016-146113 filed on Jul. 26, 2016 including the specification, drawings and abstract is incorporated herein by reference in its entirety.

### BACKGROUND OF THE INVENTION

### 1. Field of the Invention

The present invention relates to a method for manufacturing an aluminum die-casing article for plastic working that constitutes a fixation structure between a vibration-damping device or a vibration-damping hose component and a vibration transmission member by plastic working, and relates to the fixation structure using the aluminum die-casting article.

### 2. Description of the Related Art

From the past, there has been a fixation structure wherein a vibration-damping device, a vibration-damping hose component, or the like is fixed by plastic working to a vibration transmission member such as a bracket or a ferrule. Specifically, for example in Japanese Unexamined Patent Publication No. JP-A-H09-049540, a second mounting member, which constitutes a vibration-damping device, is fixed by plastic working like swaging etc., to a bracket as a vibration transmission member to be mounted to a vehicle body or the like.

The second mounting member configured to be fixed to the bracket by the plastic working was generally a high rigidity member formed of iron in the past. However, in order to meet a high demand for lightening, use of the second mounting member formed of an aluminum alloy was started recently. Particularly, a die-casting article of the aluminum alloy formed by normal die casting is suitable for mass production of a product, and it has advantages, e.g., a great degree of freedom for product shape because of molding. Therefore, wide range application of the aluminum-alloy die-casing article by normal die casting has been studied.

However, if the second mounting member that must undergo plastic deformation after molding is manufactured as an aluminum-alloy die-casing article, it may be more likely to cause split, crack, rift and the like during the plastic working like swaging etc., compared to the second mounting member formed of iron. That is, for a normal die-casting article of the aluminum alloy, the molten metal is rapidly cooled by contact with a mold during the molding. Due to the rapid cooling, a fine and hard solidified layer (chill layer) is formed at a superficial layer of the article, so that cracking in the superficial layer easily occurs during the plastic working. As a result, the fixation structure by the plastic deformation of the aluminum-alloy die-casing article is difficult to apply to a part requiring fixation reliability, durability, fixation strength and the like such as the fixation structure between the second mounting member and the bracket. Especially, the fixation structure by the plastic working of the aluminum-alloy die-casing article is difficult to use for the fixation structure between the vibration-damping device and the vibration transmission member, which receives vibration input.

Another example of the fixation structure using plastic working is a fixation structure between a hose main unit and a ferrule inserted in an end part of the hose main unit, which is made by plastic working such as diameter constricting of a ring-shaped swage metal fitting that is disposed externally about the end part of the hose main unit, which is a vibration-damping hose component. If this swage metal fitting is an aluminum-alloy die-casing article, it may be damaged in the plastic working like the diameter constricting, whereby the reliability and the durability of the fixation structure are difficult to keep.

### SUMMARY OF THE INVENTION

It is therefore one object of the present invention to provide a novel method for manufacturing an aluminum die-casting article for plastic working, which is resistant to cracking in the plastic working and thus can be used even for a fixation structure that receives vibration input, and a novel fixation structure using the aluminum die-casting article.

The above and/or optional objects of this invention may be attained according to at least one of the following modes of the invention. The following modes and/or elements employed in each mode of the invention may be adopted at any possible optional combinations.

Specifically, a first mode of the present invention provides a method for manufacturing an aluminum die-casting article for plastic working constituting a fixation structure between a vibration-damping device or a vibration-damping hose component and a vibration transmission member by plastic working, the method comprising: a die casting step of molding the aluminum die-casting article for plastic working, by normal die casting; and a heat treatment step of performing annealing heat treatment on the molded aluminum die-casting article for plastic working.

According to the method for manufacturing the aluminum die-casting article of the first mode, the solidified layer formed in the surface of the aluminum die-casting article for plastic working (chill layer) is soften through the heat treatment. This improves tenacity in relation to plastic working, thereby preventing cracking etc. during the plastic working.

Moreover, the fixation structure between the vibration-damping device or the vibration-damping hose component and the vibration transmission member that receives vibration input is constituted by the aluminum die-casting article for plastic working that is avoided from cracking during the plastic working by the heat treatment. Consequently, the durability and the reliability of the fixation structure are improved.

A second mode of the present invention provides the method for manufacturing the aluminum die-casting article for plastic working according to the first mode, wherein the annealing heat treatment is performed for 1.5 to 3 hours.

According to the second mode, the time for the heat treatment is 1.5 hours or longer. Consequently, it is possible to effectively avoid the aluminum die-casting article for plastic working from cracking etc. during the plastic deformation by low heat treatment. In addition, the time for the heat treatment is three hours or shorter, so that it is possible to manufacture the aluminum die-casting article for plastic working with excellent productivity.

A third mode of the present invention provides the method for manufacturing the aluminum die-casting article for plastic working according to the first or second mode, wherein the annealing heat treatment is performed at a temperature of 330 to 400° C.

According to the third mode, the temperature for the heat treatment is 330° C. or higher. Thus, it is possible to effectively prevent cracking etc. during the plastic deformation of the aluminum die-casting article for plastic working by low heat treatment. Also, the temperature for the heat treatment is 400° C. or lower. Therefore, for the aluminum die-casting article for plastic working, it is possible to prevent dimensional change due to thermal expansion during the heat treatment, deformation due to expansion of a gas in blow holes, and the like, thereby obtaining a product of high accuracy.

A fourth mode of the present invention provides the method for manufacturing the aluminum die-casting article for plastic working according to any one of the first to third modes, wherein a surface hardness of the aluminum die-casting article for plastic working is made 74 HV or lower by the annealing heat treatment.

According to the fourth mode, the solidified layer of the surface of the aluminum die-casting article for plastic working formed due to the contact with the mold during normal die casting has a hardness of 74 HV or lower by the heat treatment. Owing to this, when the plastic working like swaging or bending is applied on the aluminum die-casting article for plastic working, it is hardly to crack. Consequently, it is possible to provide the aluminum die-casting article excellent as one for plastic working.

A fifth mode of the present invention provides a fixation structure between a vibration-damping device or a vibration-damping hose component and a vibration transmission member comprising: a first fixation part provided at one of (i) the vibration-damping device or the vibration-damping hose component and (ii) the vibration transmission member; and a second fixation part provided at another one of (i) the vibration-damping device or the vibration-damping hose component and (ii) the vibration transmission member, wherein the first fixation part is constituted by the aluminum die-casting article for plastic working according to any one of the first to fourth modes, and the first fixation part is subjected to plastic working so that the first fixation part is fixed to the second fixation part.

According to the fixation structure following the fifth mode, the aluminum die-casting article for plastic working that prevents cracking or the like due to the plastic working is used for the fixation structure that fixes the vibration-damping device or the vibration-damping hose component and the vibration transmission member. This realizes the reliability of the fixation strength, the durability in relation to an input from outside, and the like.

In the present invention, in manufacturing the aluminum die-casting article for plastic working, the heat treatment step of performing annealing heat treatment on the aluminum die-casting article for plastic working formed by normal die casting is provided. This avoids cracking etc. of the aluminum die-casting article for plastic working during the plastic working, thereby improving the durability and the reliability. Particularly, relative to the aluminum die-casting article for plastic working that constitutes the fixation structure between the vibration-damping device or the vibration-damping hose component and the vibration transmission member by the plastic working, cracking etc. during the plastic working is prevented by the heat treatment. Owing to this, with the fixation structure that receives vibration input, the durability, the reliability and the like are improved.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a perspective view showing a vibration-damping device in the form of an engine mount as a first embodiment of the present invention;

FIG. 2 is a longitudinal cross sectional view of the engine mount shown in FIG. 1, taken along line 2-2 of FIG. 3;

FIG. 3 is a cross sectional view taken along line 3-3 of FIG. 2;

FIG. 4 is a front view of a bracket to be attached to the engine mount shown in FIG. 1;

FIG. 5 is a cross sectional view taken along line 5-5 of FIG. 4;

FIG. 6 is a cross sectional view taken along line 6-6 of FIG. 4;

FIGS. 7A and 7B are views showing an attachment step of the bracket to the engine mount, wherein FIG. 7A illustrates the state before plastic working of swage pins while FIG. 7B illustrates the state after the plastic working of the swage pins;

FIG. 8 is a graph showing a relation between time for heat treatment and surface hardness for the swage pins of the engine mount;

FIG. 9 is a view showing a vibration-damping hose as a second embodiment of the present invention; and

FIG. 10 is a view showing a vibration-damping hose as another embodiment of the present invention.

### DETAILED DESCRIPTION OF PREFERRED EMBODIMENTS

There will be described hereinafter the embodiments of the present invention while referring to the drawings.

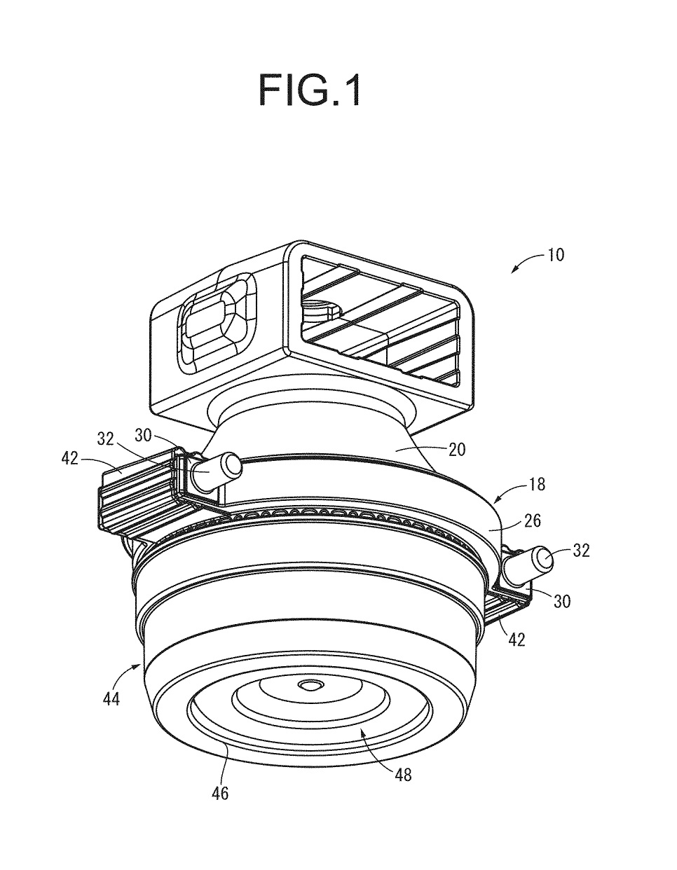

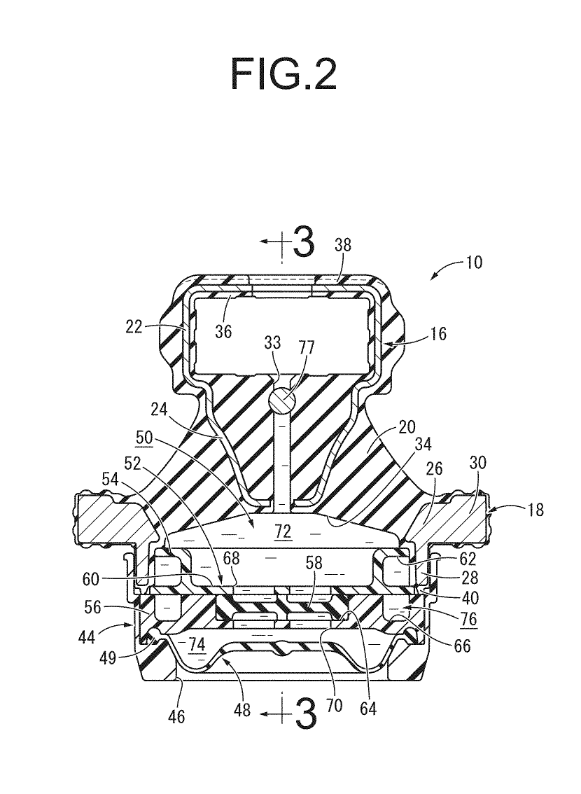

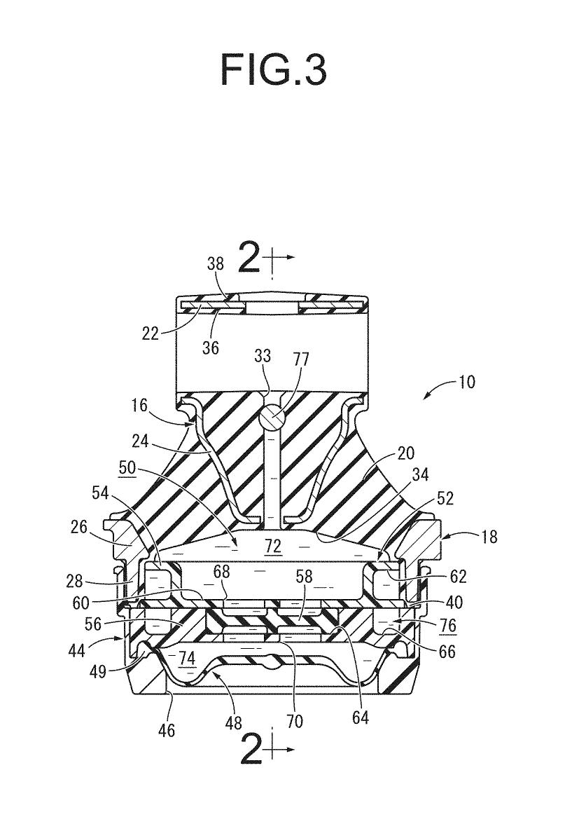

FIGS. 1 to 3 show an automotive engine mount 10 as a first embodiment of a vibration-damping device according to the present invention. The engine mount 10 comprises a first mounting member 16, a second mounting member 18 as an aluminum die-casting article for plastic working according to this invention, and a main rubber elastic body 20 elastically connecting them to each other. In this embodiment, the up-down direction means the up-down direction in FIG. 2, which is the main vibration input direction and the generally vertical direction in the mounted state on the vehicle. Additionally, the left-right direction means the left-right direction in FIG. 3, which is the roughly left-right direction of the vehicle in the mounted state on the vehicle. The front-back direction means the left-right direction in FIG. 2, which is the nearly front-back direction of the vehicle in the mounted state on the vehicle.

More specifically, the first mounting member 16 is a high rigidity member formed of a metal such as an aluminum alloy, or the like. As FIGS. 2 and 3 show, the first mounting member 16 includes a tubular part 22 having a roughly rectangular tube shape with round corners that extends in the left-right direction, and a cup-shaped inner bonded part 24 that is integrally formed at the central portion of the lower wall of the tubular part 22. The tubular part 22 and the inner bonded part 24 are integrally formed by press working. The upper end of the inner bonded part 24 is connected with the lower wall of the tubular part 22, while the inner bonded part 24 has a concave shape opening to the inner space of the tubular part 22. At each of the center of the upper wall of the tubular part 22 and the center of the inner bonded part 24, a circular hole is formed to pass through in the up-down direction.

The second mounting member 18 is a high rigidity member formed by normal die casting of an aluminum alloy, integrally including an annular outer bonded part 26 and a tubular linkage part 28 extending out downward from the outer bonded part 26. In the second mounting member 18, a pair of guide parts 30, 30 are integrally formed projecting outward in the front-back direction from the outer bonded part 26. This guide part 30 extends in the left-right direction with a cross sectional shape corresponding to a guide groove 84 that will be described later. The upper face of the guide part 30 is an incline that is inclined downward relative to a horizontal surface as it goes to the right side, while the lower face of the guide part 30 is a plane that is not inclined relative to the horizontal surface, so that the up-down dimension of the guide part 30 gets smaller as it goes to the right side.

With each guide part 30 of the second mounting member 18, a swage pin 32 as a first fixation part is integrally formed protruding to the right side. The swage pin 32 has a cylindrical shape extending linearly with a roughly constant cross sectional shape, while the radially outer face of the protruding tip is a tapered face, whereby the protruding tip has a smaller diameter as it goes to the tip side. The entire swage pin 32 may be a frustum shape whose diameter becomes gradually smaller as it goes to the protruding tip.

The first mounting member 16 and the second mounting member 18 are co-axially disposed to be separated from each other in the up-down direction, and elastically connected by the main rubber elastic body 20. The main rubber elastic body 20 has a shape of a generally truncated cone. The small-diameter side end of the main rubber elastic body 20 is bonded by vulcanization on the inner bonded part 24 of the first mounting member 16, while the large-diameter side end of the main rubber elastic body 20 is bonded by vulcanization on the outer bonded part 26 of the second mounting member 18. In this embodiment, the main rubber elastic body 20 is bonded also on the inside of the inner bonded part 24 such that the inner bonded part 24 is bonded to the main rubber elastic body 20 as embedded therein. Moreover, a liquid injection hole 33 is formed at the diametrical center portion of the main rubber elastic body 20 to extend in the up-down direction. The upper end of this liquid injection hole 33 opens to the internal space of the tubular part 22 of the first mounting member 16. On the other hand, the lower end of the liquid injection hole 33 opens to the lower face of the main rubber elastic body 20 through the lower wall of the inner bonded part 24 of the first mounting member 16. Note that the main rubber elastic body 20 takes the form of an integrally vulcanization molded component incorporating the first mounting member 16 and the second mounting member 18.

In the main rubber elastic body 20, a large-diameter recess 34 of about inverted bowl shape opening to its large-diameter side end face is formed. Thus, the main rubber elastic body 20 has rubber legs extending in directions in which the inner bonded part 24 and the outer bonded part 26 face each other, in the longitudinal cross sectional shape thereof. The lower end of the liquid injection hole 33 of the main rubber elastic body 20 opens to the upper base wall face of the large-diameter recess 34.

In the present embodiment, for the tubular part 22 of the first mounting member 16, the inner face is covered with a fitting rubber layer 36 that is integrally formed with the main rubber elastic body 20, while the outer peripheral face is covered with a buffering rubber layer 38 that is integrally formed with the main rubber elastic body 20. For the second mounting member 18, the linkage part 28 is covered by a seal rubber 40 that is integrally formed with the main rubber elastic body 20, while the up-down faces and the front-back face of the guide part 30 are covered by a cover rubber 42 that is integrally formed with the main rubber elastic body 20. The upper face of the buffering rubber layer 38 bonded on the upper face of the tubular part 22 is an incline that is inclined downward to both left-right outsides.

A cup member 44 is attached to the second mounting member 18. The cup member 44 is a member formed of a synthetic resin etc. whose whole shape is about bottomed cylinder. At the bottom wall of the cup member 44, a passage hole 46 is formed to pass through it in the up-down direction. The circumferential wall of the cup member 44 is provided with a step at the up-down middle portion, so that the circumferential wall has a larger diameter in the upper part of the step than in the lower part of the step. The cup member 44 is attached to the second mounting member 18, by the upper part of the circumferential wall thereof with the larger diameter being fitted externally about the linkage part 28 of the second mounting member 18. Thus, the cup member 44 is disposed on the side of the second mounting member 18 that is opposite to the first mounting member 16 (the lower side). The shape of the cup member 44 is stabilized by thickening the upper end of the cup member 44.

To the second mounting member 18 and the cup member 44, a flexible film 48 and a partition member 52 are attached. The flexible film 48 is formed of an elastomer like a rubber, and its entire shape is roughly thin circular disk. A sealing part 49 provided at the radially outer end of the flexible film 48 is clamped in the up-down direction between the bottom wall of the cup member 44 and the partition member 52 described later. By so doing, the flexible film 48 is attached to the second mounting member 18 and the cup member 44, thereby closing the passage hole 46 of the cup member 44 in a fluidtight manner. Consequently, a fluid chamber 50 is defined between the main rubber elastic body 20 and the flexible film 48. For the fluid chamber 50, a portion of its wall is constituted by the main rubber elastic body 20 while another portion thereof is constituted by the flexible film 48. Additionally, a non-compressible fluid or liquid is sealed in the fluid chamber 50. The non-compressible fluid sealed in the fluid chamber 50 is not especially limited. Examples of a preferably adopted fluid are water, ethylene glycol, alkylene glycol, polyalkylene glycol, silicone oil, and a mixture liquid of some of them. Moreover, the non-compressible fluid sealed in the fluid chamber 50 is desired to be a low-viscosity fluid having viscosity of 0.1 Pa·s or lower, so as to advantageously obtain vibration-damping effect owing to an orifice passage 76 described later and the like.

The partition member 52 has a substantially circular disk shape as a whole and a structure including an upper partition component 54, a lower partition component 56 and a movable film 58 disposed in between. The upper partition component 54 is a rigid member formed of a metal or a synthetic resin, wherein the center part has a circular central concavity 60 opening to the upper side, while the peripheral rim has an upper circumferential groove 62 that opens to the radially outer face and extends in the circumferential direction with a length less than one circumference. Meanwhile, the lower partition component 56 is a rigid member like the upper partition component 54, wherein the center part has a circular housing concavity 64 opening to the upper side, while the peripheral part has a lower circumferential groove 66 that opens to the upper surface and extends in the circumferential direction with a length less than one circumference. The lower partition component 56 has a larger diameter than that of the upper partition component 54. That is, the upper partition component 54 and the lower partition component 56 are configured such that, in a state described later where they are superposed on each other in the up-down direction, the lower circumferential groove 66 and the upper circumferential groove 62 are located in roughly the same diametrical position while the outer peripheral rim of the lower partition component 56 reaches to the radially outside further than the lower circumferential groove 66.

The upper partition component 54 and the lower partition component 56 are superposed on each other in the up-down direction, whereby the opening of the housing concavity 64 is covered by the upper partition component 54 so as to form a housing space, and the movable film 58 is disposed in the housing space. The movable film 58 is a member formed of an elastomer like a rubber in a circular disk shape. In the movable film 58, the outer peripheral rim includes a clasped part that protrudes to both sides in the thickness direction and extends circumferentially in an annular shape, while the radially inner part integrally includes ribs that protrude to both sides in the thickness direction and extend in a radial fashion. This movable film 58 is arranged in the housing concavity 64 of the lower partition component 56 and disposed between the upper partition component 54 and the lower partition component 56 mutually superposed in the up-down direction. In addition, by upper through holes 68 formed through the bottom wall of the central concavity 60 in the upper partition component 54 and lower through holes 70 formed through the bottom wall of the housing concavity 64 in the lower partition component 56, the movable film 58 is exposed to the outside of the upper and lower partition components 54, 56.

The partition member 52 with this structure is disposed in the fluid chamber 50. More specifically, the upper partition component 54 is inserted into the linkage part 28 of the second mounting member 18, while the lower partition component 56 is inserted into the lower part of the circumferential wall of the cup member 44. Thus, the upper and lower partition components 54, 56 are disposed between the second mounting member 18 and the cup member 44 in the up-down direction. Also, the peripheral part of the lower partition component 56 is overlapped with the sealing part 49 of the flexible film 48, so that the sealing part 49 is clamped between the lower partition component 56 and the bottom wall of the cup member 44 in the up-down direction.

The partition member 52 is disposed in the fluid chamber 50, whereby the fluid chamber 50 is divided into two on the upper and lower sides of the partition member 52. One formed on the upper side of the partition member 52 is a pressure-receiving chamber 72 whose wall is partially constituted by the main rubber elastic body 20, while the other formed on the lower side of the partition member 52 is an equilibrium chamber 74 whose wall is partially constituted by the flexible film 48.

Furthermore, the upper circumferential groove 62 of the upper partition component 54 is covered by the linkage part 28 of the second mounting member 18, while the lower circumferential groove 66 of the lower partition component 56 is covered by the upper partition component 54. Additionally, the upper circumferential groove 62 and the lower circumferential groove 66 are connected to each other at their circumferential ends, thereby forming a tunnel-shaped passage extending in the circumferential direction. Since one end of the tunnel-shaped passage is connected to the pressure-receiving chamber 72 while the other end thereof is connected to the equilibrium chamber 74, the orifice passage 76 is formed to connect the pressure-receiving chamber 72 and the equilibrium chamber 74 to each other. For the orifice passage 76, by setting the ratio of the passage cross sectional area A to the passage length L (A/L) as appropriate considering the wall spring rigidity of the fluid chamber 50, the resonance frequency of the non-compressible fluid flowing through the passage (the tuning frequency) is adjusted to a low frequency of about 10 Hz corresponding to engine shake.

Also, the liquid pressure of the pressure-receiving chamber 72 is applied to the upper face of the movable film 58 via the upper through holes 68, while the liquid pressure of the equilibrium chamber 74 is applied to the lower face of the movable film 58 via the lower through holes 70. Consequently, the movable film 58 can be subject to elastic deformation in the up-down direction based on the liquid pressure difference between the pressure-receiving chamber 72 and the equilibrium chamber 74. The resonance frequency of the movable film 58 is adjusted so that the movable film 58 undergoes deformation in a resonant state upon input of a vibration with a higher frequency than the tuning frequency of the orifice passage 76. In the present embodiment, the resonance frequency of the movable film 58 is tuned to a level of some dozen Hz corresponding to idling vibration.

The engine mount 10 shown in the present embodiment has a later liquid injection structure wherein the integrally vulcanization molded component of the main rubber elastic body 20, the cup member 44, the flexible film 48, and the partition member 52 are combined before the non-compressible fluid is injected into the fluid chamber 50. Specifically, after the above-referenced members are assembled, a not-shown nozzle is inserted into the liquid injection hole 33 of the main rubber elastic body 20, and then a prescribed amount of the non-compressible fluid is injected in the fluid chamber 50 from the nozzle. Additionally, after completion of injection of the non-compressible fluid into the fluid chamber 50, a spherical plug member 77 is fitted in the liquid injection hole 33. Thus, the plug member 77 closes the liquid injection hole 33 in a fluidtight manner, so that the non-compressible fluid is sealed in the fluid chamber 50. The engine mount 10 is not limited to the later liquid injection structure. For example, it is possible to perform the assembly work of all the above-mentioned members in a cistern filled with the non-compressible fluid, thereby filling the non-compressible fluid at the same time as the assembly.

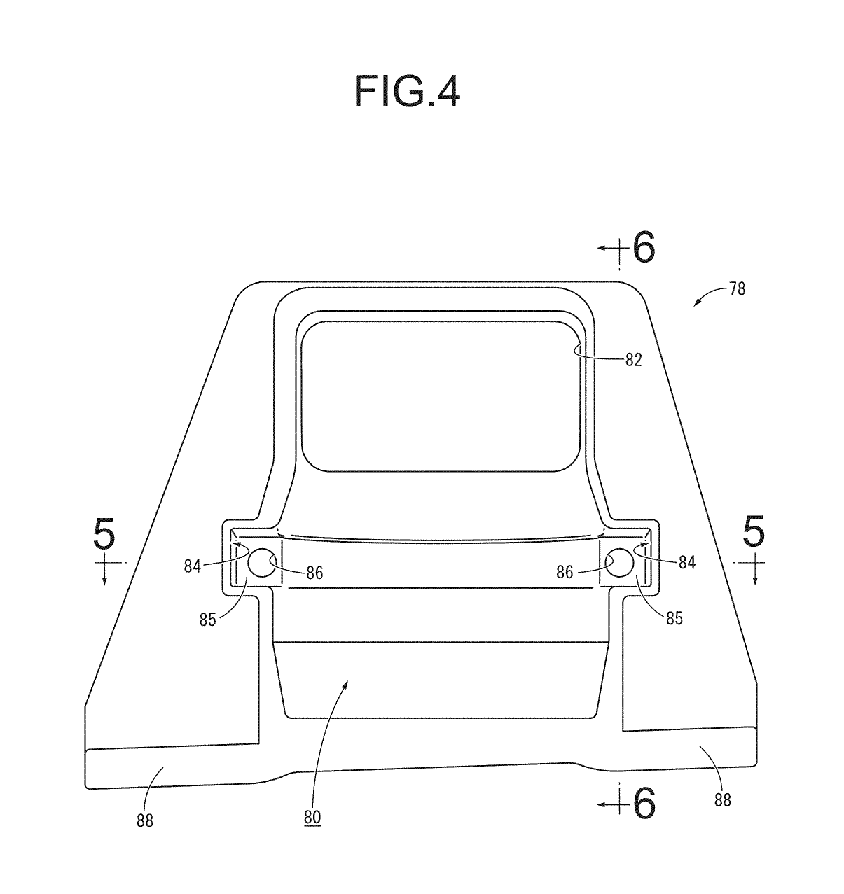

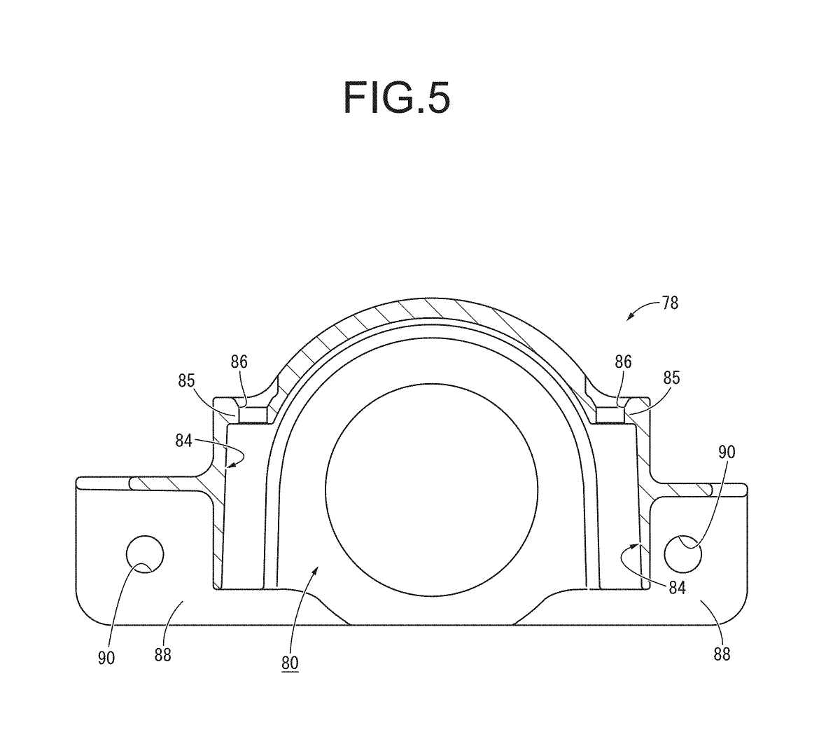

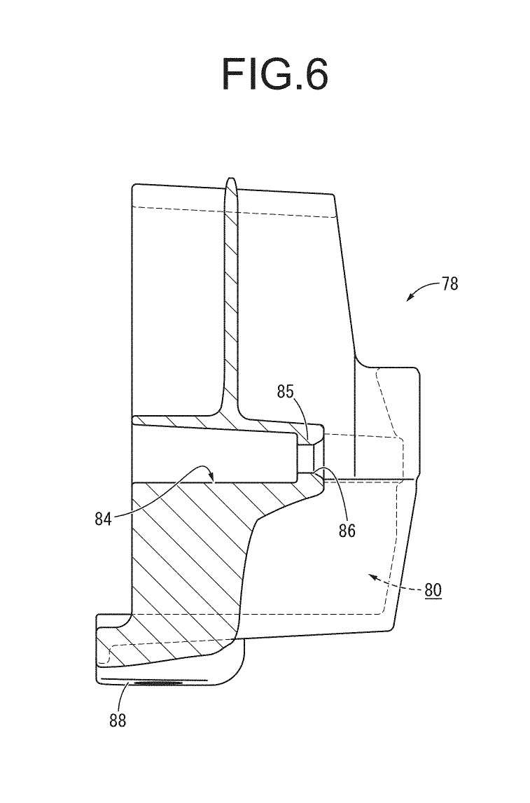

To the engine mount 10 having this structure, a bracket 78 is attached. The bracket 78 is a high rigidity member formed of a metal such as an aluminum alloy in a concave shape with an attachment void 80 opening to the left side, as FIGS. 4 to 6 show. At the upper part of the right wall of the bracket 78, a window 82 is formed through it in the left-right direction, i.e., the attachment void 80 opens to the right side through the window 82.

In each of the front and back walls of the bracket 78, a guide groove 84 is formed extending linearly in the left-right direction while opening to the front-back inside. This guide groove 84 has a groove shape that generally corresponds to the guide part 30 of the second mounting member 18 so that the guide part 30 can be inserted in the guide groove 84. For the guide grooves 84, 84, the upper inner faces are inclines that are inclined downward as they go to the right side, while the lower inner faces are faces that are not inclined, or expand in the direction orthogonal to the up-down direction.

The right end of the guide groove 84 is obstructed, except a swage hole 86 is formed through an engagement wall 85 as a second fixation part that obstructs the right end of the guide groove 84. The swage hole 86 extends linearly in the left-right direction with a cross sectional shape that corresponds to the swage pin 32 of the second mounting member 18. In the present embodiment, the swage hole 86 has a larger diameter than that of the swage pin 32 so that the swage pin 32 can be inserted into the swage hole 86 with a gap.

At the bracket 78, mounting pieces 88, 88 are formed projecting to the front-back outsides. The mounting piece 88 has a plate shape having a bolt hole 90 that pierces it roughly in the up-down direction so that it can be fixed to a constituent member of the vibration transmission system like the vehicle body etc.

The bracket 78 is attached to the engine mount 10. Specifically, the engine mount 10 is inserted in the attachment void 80 of the bracket 78 in the lateral direction, whereby the bracket 78 is attached to the engine mount 10 in a state where the engine mount 10 is housed within the attachment void 80 of the bracket 78.

The pair of guide parts 30, 30 provided at the second mounting member 18 of the engine mount 10 are fitted in the pair of guide grooves 84, 84 of the bracket 78, whereby the bracket 78 is securely attached to the second mounting member 18. In this embodiment, the cover rubber 42 is provided on the faces of the pair of guide parts 30, 30. Thus, owing to elastic deformation of the cover rubber 42, dimensional error between the guide parts 30, 30 and the guide grooves 84, 84 is allowed, while the guide parts 30, 30 are not likely to slip out of the guide grooves 84, 84.

The engine mount 10 is compressed in the up-down direction when the bracket 78 is attached. Specifically, the main rubber elastic body 20 of the engine mount 10 is pre-compressed in the up-down direction, while a compression force in the up-down direction is applied on the part of the engine mount 10 between the second mounting member 18 and the cup member 44. Consequently, sealing performance of the wall of the fluid chamber 50 is improved. More specifically, the lower face of the upper wall of the bracket 78 is an incline, while the lower faces of the guide grooves 84, 84 are faces that are not inclined. Therefore, by fitting the engine mount 10 in the bracket 78 to the right side, the main rubber elastic body 20 of the engine mount 10 is compressed in the up-down direction. Meanwhile, the upper face of the lower wall of the bracket 78 is a face that is not inclined, while the upper faces of the guide grooves 84, 84 are inclines. Therefore, by fitting the engine mount 10 in the bracket 78 to the right side, the sealing part 49 of the flexible film 48 of the engine mount 10 is compressed in the up-down direction.

In this embodiment, before the bracket 78 is attached, the engine mount 10 is temporarily sealed with some extent of sealing kept for junctures between the members constituting the wall of the fluid chamber 50, i.e., the second mounting member 18, the partition member 52, and the cup member 44. Then, before the bracket 78 is attached, the non-compressible fluid is filled in the fluid chamber 50. However, it is not necessary to ensure the sealing for the wall of the fluid chamber 50 before the attachment of the bracket 78, that is, the engine mount 10 may be configured such that it obtains the sealing by the attachment of the bracket 78. In this case etc., it is also possible to fill the non-compressible fluid in the fluid chamber 50 after the attachment of the bracket 78 to the engine mount 10.

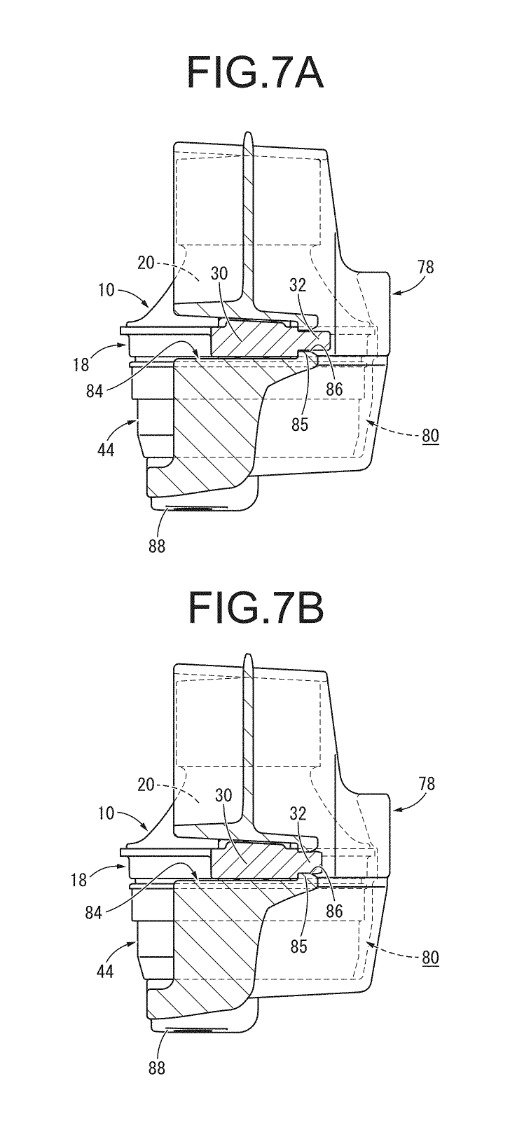

As FIG. 7A shows, the swage pins 32 provided protruding at the pair of guide parts 30, 30 are inserted through the swage holes 86, 86 formed in the engagement walls 85, 85 located at the right ends of the pair of guide grooves 84, 84. Additionally, as FIG. 7B shows, the tip part of the swage pin 32 is fastened to the engagement wall 85 at the opening peripheral edge of the swage hole 86 by plastic working (swaging). Thus, the fixation structure between the engine mount 10, which is a vibration-damping device, and the bracket 78, which is a vibration transmission member, is constituted by plastic working of the swage pin 32 as the first fixation part, which is a part of the aluminum die-casting article for plastic working. Specifically, separation (dislodgment) of the second mounting member 18 and the bracket 78 in the left-right direction is avoided by engagement between the swage pin 32 as the first fixation part and the engagement wall 85 as the second fixation part.

Swaging is one of process methods for jointing a plurality of parts. In the present embodiment, plastic working such as bending or crushing is applied to the swage pin 32 inserted through the swage hole 86, whereby the swage pin 32 is engaged in the engagement wall 85 at the opening peripheral edge of the swage hole 86. As a result, the second mounting member 18 including the swage pin 32 and the bracket 78 including the engagement wall 85 are inseparably fixed to each other. According to this, the outer diameter of the swage pin 32 before the swaging can be made smaller than the inner diameter of the swage hole 86. Thus, compared to press-fit fixation of the swage pin 32 to the swage hole 86, it is easier to insert the swage pin 32 through the swage hole 86. In this embodiment, as FIGS. 7A and 7B show, the diameter of the tip part of the swage pin 32 that protrudes to the right side beyond the swage hole 86 is expanded by crushing in the left-right direction, whereby the swage pin 32 is engaged in the engagement wall 85 at the opening peripheral edge of the swage hole 86. However, for example, it is also possible to engage the swage pin 32 in the engagement wall 85 at the opening peripheral edge of the swage hole 86 by bending the tip part of the swage pin 32 in the up-down direction or the left-right direction.

After die casting, the second mounting member 18 having the swage pins 32 is subjected to annealing heat treatment, in order to avoid problems such as cracking (rifting) in the chill layer formed at the surface of the aluminum die-casting article during the plastic working of the swage pins 32. There will be described hereinafter one example of manufacturing methods of the second mounting member 18.

Specifically, first, by normal die casting method, molten aluminum alloy that is molten metal is press-fitted in the cavity of the die casting mold prepared in advance with a prescribed pressure. After that, the molten aluminum alloy is solidified into a prescribed shape by cooling, and the mold is opened to draw the molded article out. Then, an aluminum-alloy die-casting article is obtained and the die casting step is finished. Note that the die casting step does not always have to involve the work of opening the mold and drawing out the article. This work may be done after completion of a cooling step after the heat treatment step described later, if the heat treatment step is performed in a state the article is housed in the mold, as will be described later. In sum, the die casting step is a step of molding the molten aluminum alloy in the mold into a prescribed shape.

A forming material of the second mounting member 18 can be employed as appropriate out of various known aluminum alloys, but an aluminum alloy for die casting is preferable as the forming material. For example, aluminum alloy for die casting Type 3 (ADC3), which is Al—Si—Mg based aluminum alloy including 9.0-11% of silicon and 0.4-0.6% of magnesium, aluminum alloy for die casting Type 12 (ADC12), which is Al—Si—Cu based aluminum alloy including 9.6-12% of silicon and 1.5-3.5% of copper, ASTM standard 365.0 (Registered Trademark Silafont-36), which is Fe—Al—Si—Mn—Mg based aluminum alloy with low Fe content, and the like can be preferably used.

In the die casting step, the aluminum die-casting article is formed by cold chamber normal die casting. Consequently, in the aluminum die-casting article, blow holes are formed by involving the air during the molding. In addition, the superficial layer part that touches the mold during the molding is rapidly cooled, thereby forming a fine solidified layer that is constituted by a minute a phase and an eutectic structure, which is called a chill layer. As a result, the superficial layer of the aluminum die-casting article is harder and less tensile than the inside thereof.

Next, annealing heat treatment is applied on the molded aluminum die-casting article. This heat treatment step is performed by heating the aluminum die-casting article molded into the prescribed shape corresponding to the second mounting member 18 to a prescribed temperature, and keeping the temperature in a prescribed period of time. More specifically, the heat treatment step is performed by heating the aluminum die-casting article to a temperature of 330 to 400° C., which is a lower temperature than that of general annealing, and keeping the heated state continuously for 1.5 to 3.0 hours. Note that, in the process of the heat treatment step, the temperature of the aluminum die-casting article does not always have to be maintained constant.

This heat treatment is applied on the molded aluminum die-casting article, thereby changing the quality of the chill layer formed at the surface of the article or destroying the chill layer. Thus, Vickers hardness of the surface of the second mounting member 18 is made 74 HV or lower, which is comparatively soft. This improves tenacity of the second mounting member 18, thereby easily avoiding cracking in the swage pin 32 during swaging. Note that the temperature and the time for the heat treatment are selected as appropriate within the above-described scope, depending on the magnitude of plastic deformation or the like required for the swage pin 32.

The aluminum die-casting article after the heat treatment is slowly cooled in a natural manner to the normal temperature (the atmosphere temperature). Alternatively, it is possible to adjust the cooling speed by cooling it while performing a specified temperature adjustment, or the like. With completion of the cooling step of the aluminum die-casting article after the heat treatment, the manufacturing process of the aluminum die-casting article for plastic working is finished, and the second mounting member 18 that is an aluminum die-casting article for plastic working is obtained as a product.

It is also possible that the aluminum die-casting article is not drawn out of the mold in the die casting step, and then the aluminum die-casting article is heated with the mold, and the heat treatment step of the aluminum die-casting article is finished in the mold. Besides, the cooling step after the heat treatment step may be also performed in a state where the aluminum die-casting article is housed in the mold. Thus, it is also possible to leave the aluminum die-casting article after the heat treatment step, instead of taking it out of the mold, and cool the aluminum die-casting article with the mold, and then open the mold so as to draw the product out.

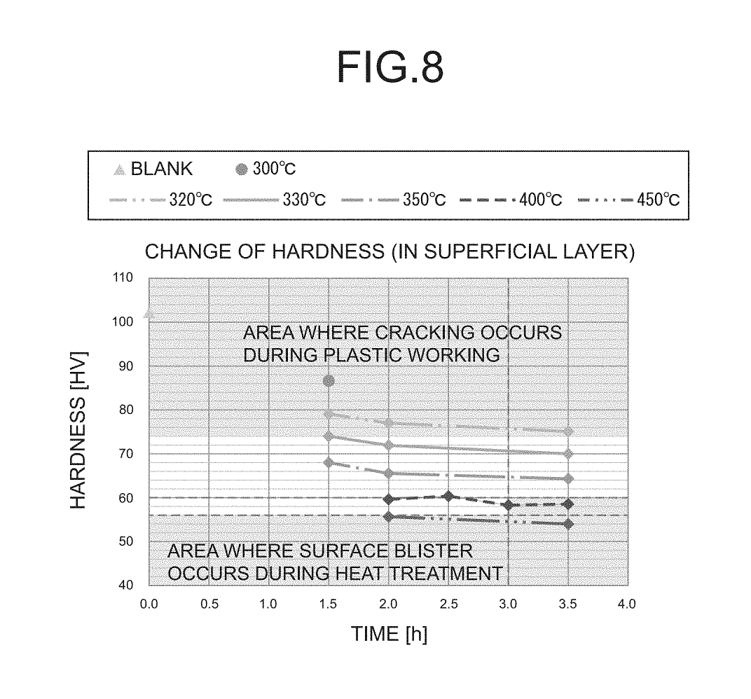

In relation to the second mounting member 18 having the swage pins 32 formed in this way, the hardness of the superficial layer is reduced by the heat treatment, so that the tenacity thereof is improved. Additionally, both cracking in the surface of the swage pin 32 during the plastic working, and bulging of the surface of the swage pin 32 caused by inflation of the blow holes in the heat treatment are prevented. This fact is confirmed also by an experiment, and the result of the experiment is shown in FIG. 8. In the graph of FIG. 8, the horizontal axis is used for the time of the heat treatment, while the vertical axis is used for the Vickers hardness of the surface of the swage pin 32. About six kinds of swage pins 32 which are subjected to the heat treatment at various temperatures, as well as the swage pin 32 which is not subjected to the heat treatment (blank), FIG. 8 shows the change of the surface hardness relative to the time of the heat treatment. Moreover, with respect to the areas painted gray in the graph of FIG. 8, the upper side part shows an area where cracking occurs in the swage pin 32 during plastic working, while the lower side part shows an area where blister occurs in the surface of the swage pin 32 during the heat treatment. The unpainted area between the upper and lower gray-painted areas is an area where it is possible to obtain good swage pins 32 having a target surface shape and being resistant to cracking during plastic working.

According to FIG. 8, in the case when the temperature of the heat treatment is 300° C. and the case when the temperature of the heat treatment is 320° C., by utility heat treatment within 3 hours, the surface hardness of the swage pin 32 was not decreased enough, and cracking occurred in the swage pin 32 during plastic working. On the other hand, when the heat treatment was performed at a high temperature of 450° C., bulging was likely to occur in the surface of the swage pin 32, so that the dimensional error became large. From the facts referred above, it is confirmed by the experiment that the temperature of the heat treatment is desirably 330 to 400° C.

Furthermore, it is also confirmed by the experiment that, in order to reduce the surface hardness of the swage pin 32 to a hardness with which rifting during plastic deformation is avoided, by the heat treatment at a temperature of 330 to 400° C., the time for the heat treatment is required to be 1.5 hours or longer.

Troubles such as split are likely to happen in the rigid superficial layer of the aluminum die-casting article molded by normal die casting method, during plastic working. According to the method for manufacturing the second mounting member 18 having these swage pins 32, the hardness of the rigid superficial layer is reduced by the heat treatment. Therefore, when swaging the swage pin 32 in a state where the swage pin 32 is inserted through the swage hole 86 of the bracket 78, rifting or the like caused by plastic deformation of the swage pin 32 is prevented, whereby the reliability, the strength, and the like about the fixation are improved. Accordingly, it becomes possible to constitute the fixation structure that receives vibration input like the swage pin 32 which is configured to be engaged in the engagement wall 85, through plastic working of the aluminum die-casting article.

Especially, the heat treatment is performed such that the Vickers hardness of the surface of the swage pin 32 is made 74 HV or lower. By so doing, the swage pin 32 becomes resistant to cracking during plastic working, so that it becomes possible to advantageously realize a linkage fixation between the engine mount 10 and the bracket 78 by the swage pins 32.

The heat treatment for the second mounting member 18 is performed at a temperature of 330° C. or higher, thereby making it possible to effectively avoid cracking during plastic deformation of the swage pin 32 through a short time period of heat treatment. Also, the temperature of the heat treatment for the second mounting member 18 is made 400° C. or lower, which is a lower temperature than that of general annealing. As a result, for the second mounting member 18, dimensional change caused by heat expansion during the heat treatment, deformation caused by inflation of the air in the blow holes, and the like are constrained. Thus, it becomes possible to obtain a product of high precision.

In addition, the time of the heat treatment for the second mounting member 18 is 1.5 hours or longer, with which cracking and the like during plastic deformation of the swage pin 32 can be effectively prevented by the heat treatment at a low temperature of 400° C. or lower. Also, the time of the heat treatment for the second mounting member 18 is 3 hours or shorter, so that the second mounting member 18 can be manufactured with excellent productivity.

In normal die casting, blow holes are formed by involving the air when the molten metal is filled into the cavity of the mold with high pressure at high speed. If heat treatment is performed on a normal die casting article, the air in the blow holes inflates and a problem such as surface blister of the article is likely to occur. Therefore, heat treatment was difficult to apply on such a normal die casting article in the past. However, if the heat treatment is performed under temperature conditions and time conditions as shown in this embodiment, it is possible to effectively obtain an effect of reducing the surface hardness without causing bulging of the surface, even relative to the aluminum die-casting article for plastic working that is formed by normal die casting (the second mounting member 18).

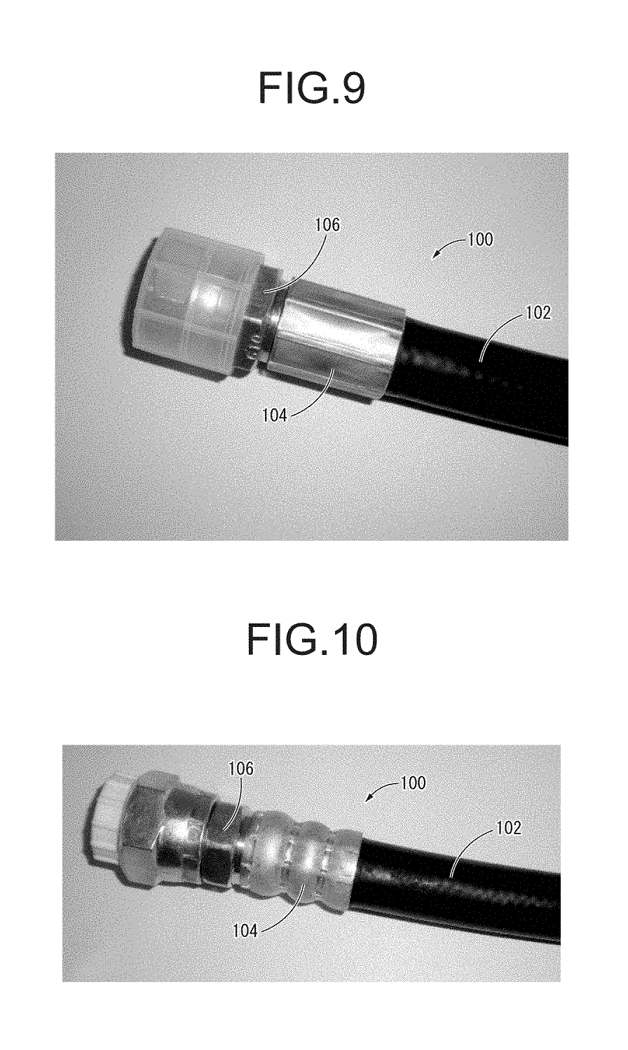

FIG. 9 shows a vibration-damping hose 100 as a second embodiment of the present invention. The vibration-damping hose 100 comprises a hose main unit 102 as a vibration-damping hose component, and a swage metal fitting 104 as an aluminum die-casting article for plastic working according to this invention, which is attached to an end part of the hose main unit 102.

The swage metal fitting 104 is configured to enclose the end part of the hose main unit 102 so as to secure a ferrule 106 as a vibration transmission member that is inserted in the end part of the hose main unit 102. Thus, the swage metal fitting 104 has a substantially cylindrical shape. This swage metal fitting 104 is disposed externally about the end part of the hose main unit 102 in which the ferrule 106 is inserted, and then fastened to the hose main unit 102 by die swaging (diameter constricting process) like 360-degree radial compression, for example. As a result, the ferrule 106 is fixed to the hose main unit 102, thereby constituting the vibration-damping hose 100. In the present embodiment, the whole swage metal fitting 104 is the first fixation part, and the swage metal fitting 104 is provided in a state it is disposed externally about the hose main unit 102 that is the hose component. On the other hand, a part of the ferrule 106 that is inserted in the hose main unit 102 is the second fixation part. The swage metal fitting 104 is fastened by swaging to the part of the ferrule 106, thereby constituting the fixation structure. Note that the specific structures of the hose main unit 102 and the ferrule 106 are just examples and can be changed as appropriate.

The swage metal fitting 104 is formed by applying the heat treatment on the aluminum die-casting article under the same conditions as those of the second mounting member 18 of the first embodiment. That is, the article molded by normal die casting of the aluminum alloy is heated to a temperature of 330 to 400° C., and the heated state is kept for 1.5 to 3 hours. By application of this heat treatment, the surface hardness of the swage metal fitting 104 is made 74 HV or lower, so that surface cracking during the plastic deformation etc. gets less likely to occur. The forming material of the swage metal fitting 104 is not particularly limited, as long as it is an aluminum alloy. As well as the second mounting member 18 of the first embodiment, ADC3, ADC12 (Japanese Industrial Standards), 365.0 (ASTM Standard), and the like can be preferably used.

According to the swage metal fitting 104 of the present embodiment, cracking etc. during the plastic working (diameter reduction process) is avoided by the heat treatment after die casting, so that it is possible to favorably realize the fixation of the ferrule 106 to the hose main unit 102. Especially, as the fixation structure between the hose main unit 102 and the ferrule 106 in the vibration-damping hose 100 that receives vibration input, the swage metal fitting 104 which is an aluminum die-casting article can be adopted.

The swage metal fitting 104 of this embodiment is subjected to diameter reduction process roughly in the same state for the entire axial length thereof, as FIG. 9 shows. Alternatively, as FIG. 10 shows, the diameter of the swage metal fitting 104 can be reduced partially at a plurality of locations separated in the axial direction so that large-diameter parts and small-diameter parts are arranged alternately in the axial direction in the swage metal fitting 104 after the plastic working.

The embodiments of the present invention have been described above, but the present invention is not limited by the specific description of the embodiments. The aforesaid embodiments are application examples of this invention, namely the fixation structure between the engine mount 10 and the bracket 78 by pin swaging, and the fixation structure between the hose main unit 102 and the ferrule 106. However, the application scope of this invention should not be interpreted in a limited way by the embodiments. Specifically, for example, in a vibration-damping device wherein a tubular second mounting member is disposed externally about an intermediate sleeve or a partition member and subjected to diameter reduction process, whereby the intermediate sleeve or the partition member is fastened to the second mounting member, the second mounting member can be an aluminum die-casting article for plastic working according to this invention. Alternatively, in a vibration-damping device comprising a tubular second mounting member, a bracket of circular disk shape, a fixation metal fitting that is fixed to the outer peripheral end of the flexible film, wherein the lower end of the tubular second mounting member is bent so as to securely engage the bracket, the fixation metal fitting and the like in the lower end, the second mounting member can be an aluminum die-casting article for plastic working according to this invention.

What is claimed is:

1. A method for manufacturing an aluminum die-casting article for plastic working constituting a fixation structure between a vibration-damping device or a vibration-damping hose component and a vibration transmission member by plastic working, the method comprising:
a die casting step of molding the aluminum die-casting article for plastic working, by normal die casting; and
a heat treatment step of performing annealing heat treatment on the molded aluminum die-casting article for plastic working.

2. The method for manufacturing the aluminum die-casting article for plastic working according to claim 1, wherein the annealing heat treatment is performed for 1.5 to 3 hours.

3. The method for manufacturing the aluminum die-casting article for plastic working according to claim 1, wherein the annealing heat treatment is performed at a temperature of 330 to 400° C.

4. The method for manufacturing the aluminum die-casting article for plastic working according to claim 1, wherein a surface hardness of the aluminum die-casting article for plastic working is made 74 HV or lower by the annealing heat treatment.

5. A fixation structure between a vibration-damping device or a vibration-damping hose component and a vibration transmission member comprising:
a first fixation part provided at one of (i) the vibration-damping device or the vibration-damping hose component and (ii) the vibration transmission member; and
a second fixation part provided at another one of (i) the vibration-damping device or the vibration-damping hose component and (ii) the vibration transmission member, wherein
the first fixation part is constituted by the aluminum die-casting article for plastic working according to claim 1, and the first fixation part is subjected to plastic working so that the first fixation part is fixed to the second fixation part.
